(19) United States
(12) Patent Application Publication
(10) Pub. No.: US 2003/0151571 A1
(43) Pub. Date: Aug. 14, 2003

(54) Liquid crystal display device capable of displaying large and small characters simultaneously

(76) Inventor: Wilson Wang, Taipei (TW)

Correspondence Address: WILSON WANG, 5 FL., No. 755, MINTZU E. ROAD, P.O. BOX 24-108, TAIPEI, TW

(21) Appl. No.: 10/074,437

(22) Filed: Feb. 13, 2002

(51) Int. Cl. G09G 3/36

(52) U.S. Cl. 345/87

(57) ABSTRACT

In a liquid crystal display device capable of display large and small characters simultaneously, upper portions or lower portions of all the longitudinal liquid crystal tubes or those at specific positions are divided in the center transversely, and a transverse liquid crystal tube is disposed between the left and right longitudinal liquid crystal tubes such that the corresponding segment circuits and common circuits are connected electrically. By activation or according to the calculation result of a control chip (CPU), the control chip can control the corresponding segment circuits and common circuits to connect electrically the upper portions or lower portions of the liquid crystal tubes that are provided with the transverse liquid crystal tubes and that are at the specific positions or that are after the decimal point so as to display small characters, whereas the liquid crystal tubes that are at the other positions are connected electrically to display large characters.

### BACKGROUND OF THE INVENTION

(a) Field of the Invention

The invention relates to a liquid crystal display that is capable of displaying large and small characters at the same time. The invention is directed to improving upon conventional liquid crystal display devices that display digits of the same size so that digits after the decimal point or for indicating specific units have to read at close range. In the invention, upper portions or lower portions of all the longitudinal liquid crystal tubes or those at specific positions are divided in the center transversely, and a transverse liquid crystal tube is disposed between the left and right longitudinal liquid crystal tubes such that the corresponding segment circuits and common circuits are connected electrically. When a control chip (CPU) is activated via an input or outputs a calculation result, the control chip controls the corresponding segment circuits and common circuits to connect electrically the upper portions or lower portions of the liquid crystal tubes that are provided with the transverse liquid crystal tubes and that are at the specific positions or that are after the decimal point so as to display small characters, whereas the liquid crystal tubes that are at the other positions are connected electrically to display large characters, thereby displaying large and small characters simultaneously to facilitate reading of the calculation result.

(b) Description of the Prior Art

In conventional devices with liquid crystal displays, such as calculators, timers, and cash registers, the screen is constituted by liquid crystal tubes in the shape of the digit “8”. The principle thereof is that, according to a calculation result, a control chip (CPU) controls the electrical connection of corresponding segment circuits and common circuits so that the corresponding liquid crystal tubes are activated to display the required digits. However, since the digits displayed are of the same size, and the decimal points or specific units (such as cents) are indicated by a very small dot. The calculation result may not be correctly read or identified from a distance, which is inconvenient.

### SUMMARY OF THE INVENTION

Therefore, the primary object of the invention is to provide a liquid crystal display device capable of displaying large and small characters simultaneously. Accordingly, in the liquid crystal display device of the invention, upper portions or lower portions of all the longitudinal liquid crystal tubes or those at specific positions are divided in the center transversely, and a transverse liquid crystal tube is disposed between the left and right longitudinal liquid crystal tubes such that the corresponding segment circuits and common circuits are connected electrically. When a control chip (CPU) is activated via an input or outputs a calculation result, the control chip controls the corresponding segment circuits and common circuits to connect electrically the upper portions or lower portions of the liquid crystal tubes that are provided with the transverse liquid crystal tubes and that are at the specific positions or that are after the decimal point so as to display small characters, whereas the liquid crystal tubes that are at the other positions are connected electrically to display large characters, thereby displaying large and small characters simultaneously to facilitate reading of the calculation result.

### BRIEF DESCRIPTION OF THE DRAWINGS

The foregoing and other features and advantages of the present invention will be more clearly understood from the following detailed description and the accompanying drawings, in which,

FIG. 1 is a front view of the preferred embodiment of the arrangement of the liquid crystal tubes according to the invention;

FIG. 2 is a schematic view illustrating the connection of the liquid crystal tubes and segment circuits according to the invention;

FIG. 3 is a schematic view illustrating the connection of the liquid crystal tubes and common circuits according to the invention;

FIG. 4 is a front view showing that the liquid crystal tubes display a small character;

FIG. 5 is a front view of the preferred embodiment of the liquid crystal display according to the invention;

FIG. 6 is a front view of another preferred embodiment of the liquid crystal tubes according to the invention;

FIG. 7 is a front view of the liquid crystal tubes of FIG. 6, in which small characters are displayed; and

FIG. 8 is a front view of still another preferred embodiment of the liquid crystal display according to the invention.

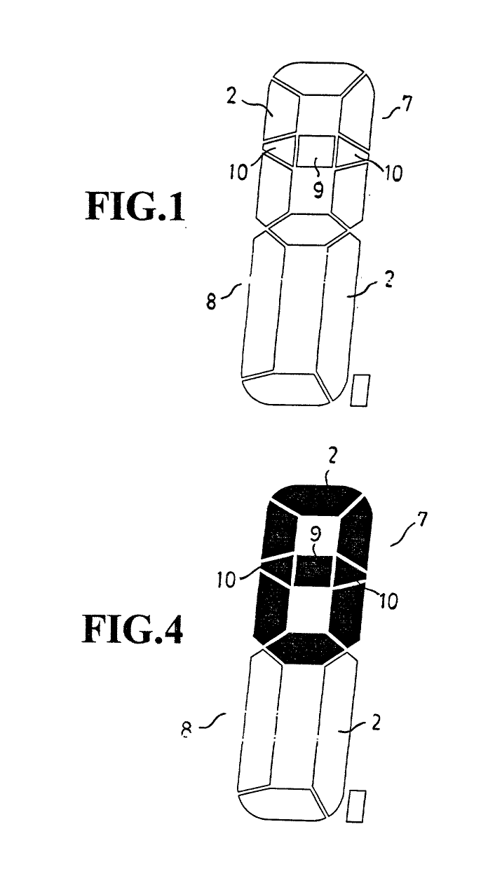

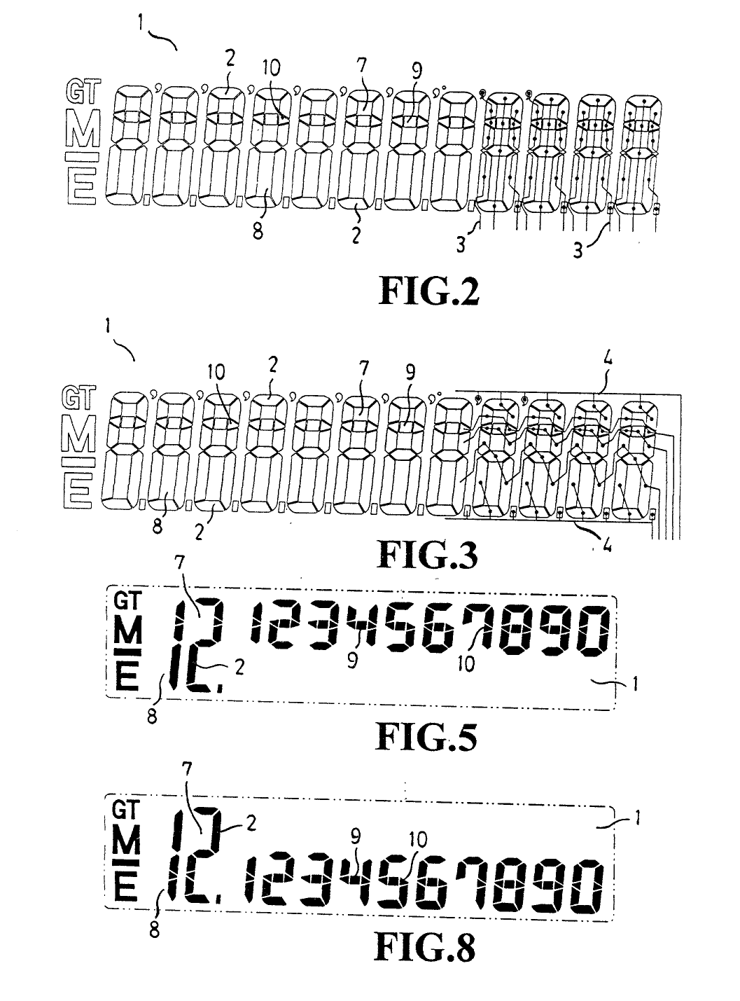

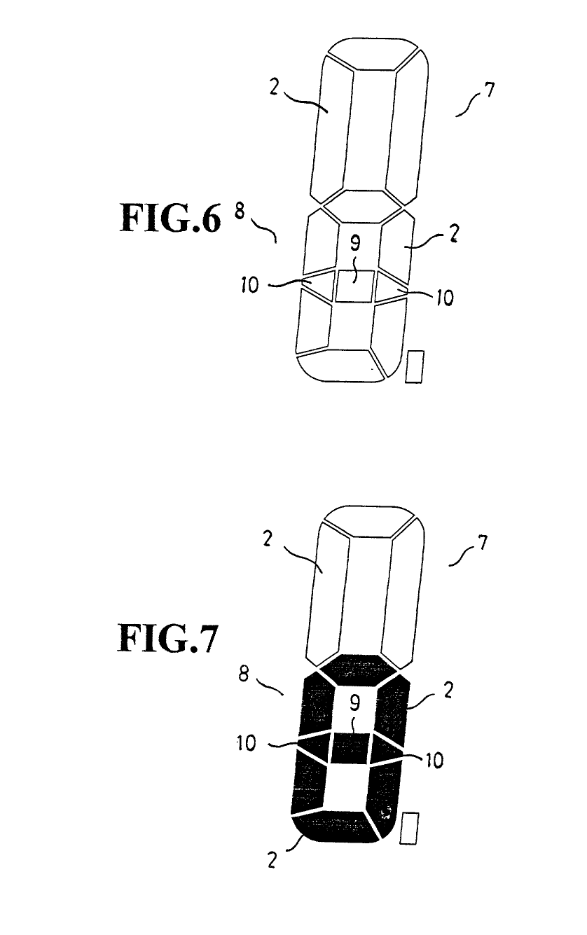

### DETAILED DESCRIPTION OF THE PREFERRED EMBODIMENTS

With reference to the drawings, a screen 1 according to the invention includes liquid crystal tubes 2, segment circuits 3, and common circuits 4. Upper portions 7 or lower portions 8 of all the longitudinal liquid crystal tubes 2 or those at specific positions (e.g., the last two corresponding to the cent unit) are divided in the center transversely, and a transverse liquid crystal tube 9 is disposed between the left and right longitudinal liquid crystal tubes 2. In order to make the digits on the screen 1 look nice and smooth, trimming liquid crystal tubes 10 can be disposed at left and right ends of the transverse liquid crystal tube 9 and at the portions where the longitudinal liquid crystal tubes 2 are divided, to thereby cause the control chip (CPU) to control connection of the corresponding segment circuits 3 and common circuits 4.

During actual operation, the control chip (CPU) is activated via a key input, such as input of decimals and cents, or a calculation result of the control chip (CPU), and the corresponding segment circuits 3 and common circuits 4 will be connected electrically, so that the upper portions 7 or lower portions 8 of the liquid crystal tubes 2 that are provided with transverse liquid crystal tubes 9 and that are at the specific positions or that are after the decimal point are shown as small characters 5, whereas the liquid crystal tubes 2 that are at the other positions are shown in large characters 6, thereby achieving the object of displaying large and small characters at the same time. By virtue of the difference in size of the digits, the user can quickly and clearly identify the calculation result and the units to prevent possible errors.

Although the present invention has been illustrated and described with reference to the preferred embodiments thereof, it should be understood that it is in no way limited to the details of such embodiments but is capable of numerous modifications within the scope of the appended claims.

What is claimed is:

1. A liquid crystal display device capable of display large and small characters simultaneously, comprising: a plurality of liquid crystal tubes that are in the form of the digit “8” and that are respectively connected to corresponding segment circuits and common circuits, according to a calculation result, a control chip (CPU) being controlled to connect electrically the corresponding segment circuits and common circuits at corresponding positions so as to activate the corresponding liquid crystal tubes to thereby achieve the liquid crystal display device for showing digits;
wherein: upper portions or lower portions of all the longitudinal liquid crystal tubes or those at specific positions are divided in the center transversely, and a transverse liquid crystal tube is disposed between the left and right longitudinal liquid crystal tubes and is connected electrically to the corresponding segment circuits and common circuits, whereby by activation or according to the calculation result of the control chip (CPU), the upper portions or lower portions of the liquid crystal tubes that are provided with the transverse liquid crystal tubes and that are at the specific positions or that are after the decimal point are controlled to display small characters, whereas the liquid crystal tubes that are at the other positions are controlled to display large characters.

2. The liquid crystal display device as claimed in claim 1, wherein the liquid crystal tubes are provided with trimming liquid crystal tubes at left and right portions of each of the transverse liquid crystal tubes and at where the liquid crystal tubes are divided, the trimming liquid crystal tubes being connected to corresponding segment circuits and common circuits.
